(19) United States
(12) Patent Application Publication
(10) Pub. No.: US 2026/0285368 A1
(43) Pub. Date: Sep. 24, 2026

(54) DRIVING ASSISTANCE CONTROL DEVICE, DRIVING ASSISTANCE METHOD, AND STORAGE MEDIUM

(71) Applicant: TOYOTA JIDOSHA KABUSHIKI KAISHA, Toyota-shi (JP)

(72) Inventors: Kazuhiro MORIMOTO, Toyota-shi (JP); Yusuke TANAKA, Toyota-shi (JP); Kohei TOSHIMA, Toyota-shi (JP); Motohiro FUKAYA, Nisshin-shi (JP)

(73) Assignee: TOYOTA JIDOSHA KABUSHIKI KAISHA, Toyota-shi (JP)

(21) Appl. No.: 19/428,812

(22) Filed: Dec. 22, 2025

(30) Foreign Application Priority Data
Mar. 19, 2025 (JP) 2025-045744

(51) Int. Cl. B60W 60/00; B60W 40/08; B60W 50/14; G06F 3/01

(52) U.S. Cl. CPC B60W 60/0015; B60W 40/08; B60W 50/14; G06F 3/017; B60W 2040/0818; B60W 2050/143; B60W 2050/146; B60W 2540/221; B60W 2540/223; B60W 2540/229; B60W 2540/26

(57) ABSTRACT

A driving assistance control device for a vehicle is configured to perform, in response to a determination that a driver of the vehicle is in an abnormal state in which the driver has difficulty in continuing to drive the vehicle, driving assistance to respond to the abnormal state of the driver, and determine, when a predetermined gesture pose is requested of the driver and the driver does not take the predetermined gesture pose, that the driver is in the abnormal state.

### CROSS-REFERENCE TO RELATED APPLICATION

This application claims priority to Japanese Patent Application No. 2025-045744 filed on March 19, 2025. The disclosure of the above-identified application, including the specification, drawings, and claims, is incorporated by reference herein in its entirety.

### BACKGROUND

### 1. Technical Field

The present disclosure relates to a driving assistance control device, a driving assistance method, and a storage medium.

### 2. Description of Related Art

Japanese Unexamined Patent Application Publication No. 2021-109559 (JP 2021-109559 A) discloses a vehicle travel control device in the related art that is configured to determine whether a driver is in an abnormal state, and to decelerate a vehicle to perform deceleration and stop control in which the vehicle is held in a stopped state when the driver is in the abnormal state. Japanese Unexamined Patent Application Publication No. 2023-72270 (JP 2023-72270 A) discloses that, in a situation where a determination is made that the eyes are closed in a closed-eye determination process, when the driver's head posture is in an abnormal posture and the closed-eye state continues for a first predetermined time, a determination is made that the driver is in an abnormal state. In a situation where a determination is made that the eyes are not closed in the closed-eye determination process, when the driver's head posture is in the abnormal posture and the state in which the eyes are not closed continues for a second predetermined time different from the first predetermined time, the driver is notified. A driver state determination method is disclosed in which, when the driver's head posture is in the abnormal posture and the driving operation amount does not change for a third predetermined time after the notification, a determination is made that the driver is in the abnormal state.

### SUMMARY

When the driver is misjudged to be in an abnormal state, the deceleration and stop control may be performed regardless of whether the driver is in a normal state. Therefore, accurately determining whether the driver is in an abnormal state by a simple method is desirable.

The present disclosure has been made in view of such problems, and an object thereof is to accurately determine whether the driver is in an abnormal state by a simple method.

In order to solve the problem described above, a driving assistance control device for a vehicle according to an aspect of the present disclosure is configured to: perform, in response to determination that a driver of the vehicle is in an abnormal state in which the driver has difficulty in continuing to drive the vehicle, driving assistance to respond to the abnormal state of the driver; and determine, when a predetermined gesture pose is requested of the driver and the driver does not take the predetermined gesture pose, that the driver is in the abnormal state.

In addition, a driving assistance method according to an aspect of the present disclosure includes:

performing, in response to determination that a driver of the vehicle is in an abnormal state in which the driver has difficulty in continuing to drive the vehicle, driving assistance to respond to the abnormal state of the driver; and determining, when a predetermined gesture pose is requested of the driver and the driver does not take the predetermined gesture pose, that the driver is in the abnormal state.

In addition, a storage medium according to an aspect of the present disclosure stores a computer program that causes a computer to execute: performing, in response to determination that a driver of a vehicle is in an abnormal state in which the driver has difficulty in continuing to drive the vehicle, driving assistance to respond to the abnormal state of the driver; and determining, when a predetermined gesture pose is requested of the driver and the driver does not take the predetermined gesture pose, that the driver is in the abnormal state.

According to these aspects of the present disclosure, it is possible to accurately determine whether the driver is in an abnormal state by a simple method.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a vehicle according to a first embodiment of the present disclosure;

FIG. 2 is a flowchart illustrating details of a driver abnormal state determination process according to the first embodiment of the present disclosure; and

FIG. 3 is a flowchart illustrating details of a gesture pose registration process according to a second embodiment of the present disclosure.

### DETAILED DESCRIPTION OF EMBODIMENTS

Hereinafter, embodiments of the present disclosure will be described in detail with reference to the drawings. In the following description, the same reference numerals are given to the same constituent elements.

### First Embodiment

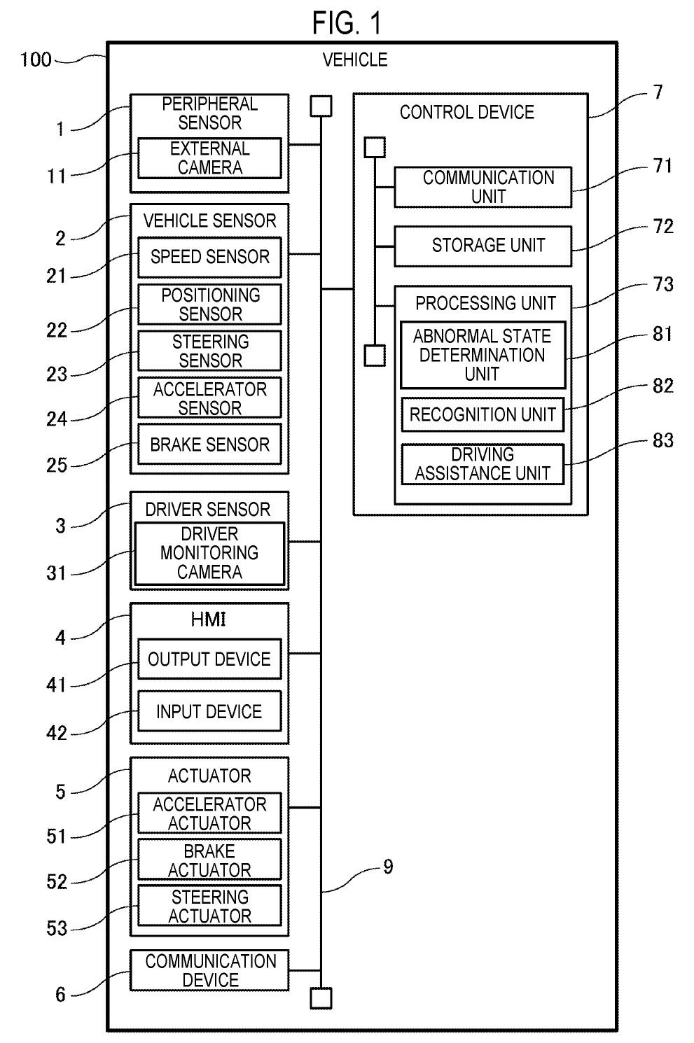

FIG. 1 is a schematic configuration diagram of a vehicle 100 according to a first embodiment of the present disclosure.

The vehicle 100 includes a peripheral sensor 1, a vehicle sensor 2, a driver sensor 3, a human machine interface (HMI) 4, an actuator 5, a communication device 6, and a control device 7. The peripheral sensor 1, the vehicle sensor 2, the driver sensor 3, the HMI 4, the actuator 5, the communication device 6, and the control device 7 are communicably connected via an in-vehicle network 9 that conforms to a standard such as a controller area network.

The peripheral sensor 1 is a sensor for generating peripheral data representing a situation around the vehicle 100. The vehicle 100 according to the present embodiment includes one or a plurality of external cameras 11 for capturing an image of the periphery of the vehicle 100 as the peripheral sensor 1. The external camera 11 captures an image of the periphery of the vehicle 100 at a predetermined frame rate (for example, 10 [Hz] to 40 [Hz]) and generates a peripheral image showing the periphery of the vehicle 100. Each time the external camera 11 generates the peripheral image, the generated peripheral image is transmitted to the control device 7 as the peripheral data.

In addition to the external camera 11, a distance measurement sensor that measures a distance to an object or a landmark present around the vehicle 100 may be provided as the peripheral sensor 1. Examples of the distance measurement sensor include a light detection and ranging (LiDAR) that emits laser light and measures a distance based on reflected light, and a millimeter wave radar sensor that emits radio waves and measures a distance based on reflected waves.

The vehicle sensor 2 is a sensor for acquiring vehicle data representing a state of the vehicle 100. The vehicle 100 according to the present embodiment includes, as the vehicle sensor 2, a speed sensor 21 that acquires speed data indicating a traveling speed of the vehicle 100, a positioning sensor 22 that acquires current position data indicating a current position of the vehicle 100 such as latitude and longitude, a steering sensor 23 that acquires data related to a steering operation such as a steering grip or a steering torque and a steering angle, an accelerator sensor 24 that acquires data related to an accelerator operation such as the depression amount of an accelerator pedal, a brake sensor 25 that acquires data related to a brake operation such as detection of brake pedal operation input, and the like. However, the vehicle sensor 2 is not limited to these sensors. Each data acquired by each of the sensors 21 to 25 is transmitted to the control device 7 as the vehicle data.

The driver sensor 3 is a sensor for generating driver data representing a state of the driver. The vehicle 100 according to the present embodiment includes a driver monitoring camera 31 for capturing an image of a driver's appearance including a face of the driver as the driver sensor 3. The driver monitor camera 31 captures an image of the driver's appearance at a predetermined frame rate (for example, 10 [Hz] to 40 [Hz]) and generates an appearance image showing the driver's appearance. Each time the driver monitoring camera 31 generates the appearance image of the driver, the generated appearance image is transmitted to the control device 7 as the driver data.

The HMI 4 is a user interface for exchanging information between the vehicle 100 and an occupant of the vehicle 100. The HMI 4 includes an output device 41 for providing notifications to the vehicle occupant through the vehicle occupant's sensory modalities (for example, visual, auditory, and tactile senses), and an input device 42 through which the vehicle occupant performs an input operation or a response operation. The output device 41 is, for example, a display (for example, a meter display, a center display, a head-up display, or the like), a speaker, or the like. The input device 42 is, for example, a touch panel, a microphone, or the like.

The HMI 4 notifies the vehicle occupant of information corresponding to an output signal received from the control device 7 via the output device 41, and transmits data input by the vehicle occupant to the control device 7 via the input device 42.

The HMI 4 may be a device that is mounted in advance in the vehicle 100, or may be a terminal such as a smartphone owned by the vehicle occupants (driver and passenger). In the latter case, for example, information may be exchanged by performing short-range wireless communication between the vehicle 100 and the terminal of the vehicle occupant. In addition, communication may be performed between the terminal of the vehicle occupant and an external server (not illustrated), and information may be exchanged indirectly via the server.

The actuator 5 is a device used for traveling control of the vehicle 100. The vehicle 100 according to the present embodiment includes, as the actuator 5, an accelerator actuator 51 (for example, at least one of an engine and a motor) that performs acceleration control of the vehicle 100, a brake actuator 52 (for example, a hydraulic actuator) that performs brake control of the vehicle 100, and a steering actuator 53 (for example, a steering motor) that performs steering control of the vehicle 100.

The communication device 6 performs wireless communication with a device (for example, a wearable device such as a smart watch or a smartphone) owned by the occupant of the vehicle 100, and transmits and receives information to and from the device.

The control device 7 is an electronic control unit (ECU) including a communication unit 71, a storage unit 72, and a processing unit 73.

The communication unit 71 includes an interface circuit for connecting the control device 7 to the in-vehicle network 9. The communication unit 71 supplies various types of data received from the outside to the processing unit 73. In addition, the communication unit 71 outputs various signals output from the processing unit 73 to the outside.

The storage unit 72 includes a storage medium such as a hard disk drive (HDD), a solid disk drive (SSD), or a semiconductor memory, and stores various computer programs, data, and the like used for processing in the processing unit 73.

The processing unit 73 includes one or a plurality of central processing units (CPUs) and a peripheral circuit thereof, and executes various computer programs stored in the storage unit 72. The processing unit 73 is, for example, a processor. The processing unit 73 may further include other arithmetic circuits such as a logic operation unit, a numerical operation unit, or a graphics processing unit. The processing unit 73 functions as an abnormal state determination unit 81, a recognition unit 82, and a driving assistance unit 83 by executing processing in accordance with a computer program, and operates as a functional unit (module) that realizes a predetermined function. In the following description, when the processing is described with each of the functional units 71 to 73 as the subject, each case shows that the processing unit 73 is executing a program that realizes each of the functional units 81 to 83.

Hereinafter, contents of specific processing executed in the control device 7 will be described. That is, contents of each of the functional unit 81 to 83 realized by the processing unit 73 executing processing in accordance with the computer program will be described.

The abnormal state determination unit 81 determines whether the driver has fallen into an abnormal state (hereinafter, simply referred to as an "abnormal state") in which the driver has difficulty in continuing driving, for example, due to a sudden change in physical condition.

The recognition unit 82 recognizes an object and a landmark around the vehicle 100. The recognition unit 82 recognizes, in the peripheral image, both an object such as another vehicle, a two-wheeled vehicle, or a pedestrian, and a landmark such as a curb or a fence or other similar structure (hereinafter, referred to as a "partition structure") or a road sign (for example, a partition line defining a traveling lane) by sequentially inputting the peripheral image received from the external camera 11 to an identifier. The identifier can be, for example, a convolutional neural network (CNN) having a plurality of convolutional layers connected in series from an input side to an output side. In addition, the recognition unit 82 calculates a distance from the vehicle 100 to the object and the landmark and calculates a position of the object and the landmark by using, for example, a standard size of the object and the landmark stored in the storage unit 72 for each type of the object and the landmark and a size of the object and the landmark recognized in the peripheral image. The method of recognizing the object and the landmark is not limited to such a method, and may be recognized by various known methods.

The driving assistance unit 83 controls the actuator 5 based on the object and the landmark recognized by the recognition unit 82 to perform driving assistance involving traveling control of the vehicle 100. In the present embodiment, the driving assistance unit 83 can perform a driving control level at level 3 defined by the Society of Automotive Engineers (SAE). That is, the driving assistance unit 83 can perform driving assistance involving traveling control of the vehicle 100 at a driving control level that does not require the driver to operate each of the actuators 51 to 53 and to monitor the periphery. In addition, the driving assistance unit 83 can perform driving assistance involving traveling control of the vehicle 100 at a driving control level in which the driver is involved in driving of the vehicle 100, for example, a driving control level of level 1 or level 2 defined by SAE.

As one type of the driving assistance involving traveling control of the vehicle 100, the driving assistance unit 83 performs driver-abnormal-state response driving assistance to respond to the abnormal state of the driver when it is determined that the driver has fallen into the abnormal state. Specifically, when it is determined that the driver has fallen into the abnormal state, the driving assistance unit 83 first performs notification control to notify the driver of a control warning (alarm) to the driver via the HMI 4. After a predetermined time has elapsed from the start of the notification, the vehicle 100 is decelerated to perform deceleration and stop control in which the vehicle 100 is held in a stopped state. That is, the driver-abnormal-state response driving assistance includes the notification control and the deceleration and stop control having deceleration control and stop-hold control. The driving assistance unit 83 may execute a measure (for example, turning on a hazard) for notifying a peripheral vehicle of the abnormality of the driver of the vehicle 100 during the driver-abnormal-state response driving assistance.

The manner in which the vehicle 100 is decelerated and stopped is not particularly limited as long as the risk of contact with a road user outside the vehicle during the execution of the deceleration and stop control is considered. For example, when the partition line of the vehicle traveling lane can be recognized, the vehicle 100 can be decelerated and held in the stopped state along the partition line of the vehicle traveling lane, when the partition line of the vehicle traveling lane cannot be recognized, the vehicle 100 can be decelerated and held in the stopped state along the trajectory of the vehicle in front, and when the partition line of the vehicle traveling lane and the vehicle in front cannot be recognized, the vehicle 100 can be decelerated and held in the stopped state while traveling straight. In addition, for example, the vehicle may change lanes and move to a lane on the roadway side or to the shoulder in consideration of the rescue of the driver or the safety of the passenger getting off the vehicle.

Here, when the determination accuracy of whether the driver has fallen into the abnormal state by the abnormal state determination unit 81 is low, the driver-abnormal-state response driving assistance may be performed even though the driver is in the normal state. Therefore, the abnormal state determination unit 81 according to the present embodiment is configured to request the driver to take a predetermined gesture, and to determine that the driver is in the abnormal state when the driver does not take the requested gesture.

For example, the abnormal state determination unit 81 instructs the driver to take the predetermined gesture pose via the output device 41 (for example, one or both of the display and the speaker), and determines that the driver is in the abnormal state when the driver fails to take the requested gesture within a predetermined time.

Whether the driver has taken the predetermined gesture pose can be confirmed, for example, by sequentially inputting the appearance image of the driver received from the driver monitor camera 31 to the identifier and detecting a position of a predetermined part such as a hand or a head of the driver in time series. The identifier can be, for example, a convolutional neural network (CNN) having a plurality of convolutional layers connected in series from an input side to an output side.

In addition, whether the driver has taken the predetermined gesture pose can be confirmed by, for example, a wearable device (for example, a smart watch) that can perform wireless communication with the control device 7. Specifically, the detection data such as movement and vibration of the muscle fiber of the driver, and pulse of the driver when the predetermined gesture pose is taken is acquired by the wearable device, and the detection data is input to a machine learning model that has been trained in advance to recognize whether the predetermined gesture pose is taken, so that it can be confirmed whether the driver has taken the predetermined gesture pose. The control device 7 can confirm whether the driver has taken the predetermined gesture pose by receiving the confirmation result information of whether the driver has taken the predetermined gesture from the wearable device. In addition, the control device 7 can receive the detection data acquired by the wearable device, and based on the detection data, confirm whether the driver has taken the predetermined gesture pose, similarly to the confirmation performed by the wearable device.

As the gesture pose, for example, a gesture pose that is unlikely to interfere with driving or can be easily taken while driving, such as a thumbs-up "good" pose, can be adopted.

The gesture pose is not limited to such a predetermined pose, and a gesture pose according to the driver's preference may be set to be registered, and the driver may be requested to take the registered gesture. In this case, the driver may be requested to take the gesture pose according to the driver's preference a plurality of times while the vehicle is stopped or the like, and the gesture pose may be stored. In addition, in order to improve the recognition accuracy of the gesture pose, even when the gesture pose is a predetermined pose such as a "good" pose, the predetermined pose may be taken a plurality of times while the vehicle is stopped or the like, and the pose may be stored.

The request for the driver to take the gesture pose may be issued periodically, or may be issued when the driver has fallen into a predetermined estimated abnormal state.

The estimated abnormal state is a state in which it is considered that the driver has fallen into the abnormal state. Examples of the estimated abnormal state include a state in which the driver's eyes are closed, a state in which the posture of the driver has collapsed, and a state in which the steering is not being operated unless the driving assistance that allows hands-off driving is being performed. The state in which the posture of the driver has collapsed refers, for example, to a state in which the driver is slumped forward, bowed down, arched backward, or with the head or upper body tilted or fallen to the side due to muscle relaxation caused by loss of consciousness or the like, or to a state in which the driver is arched backward due to rigidity caused by epilepsy or the like.

Whether the driver's eyes are closed, the posture of the driver has collapsed, or the steering is not being operated can be determined, for example, from the driver's appearance based on the image of the driver monitoring camera 31. In addition, as long as the data related to steering operation is acquired by the steering sensor 23, whether the steering is not being operated can be determined, for example, based on the data or based on the data and the image from the driver monitoring camera 31.

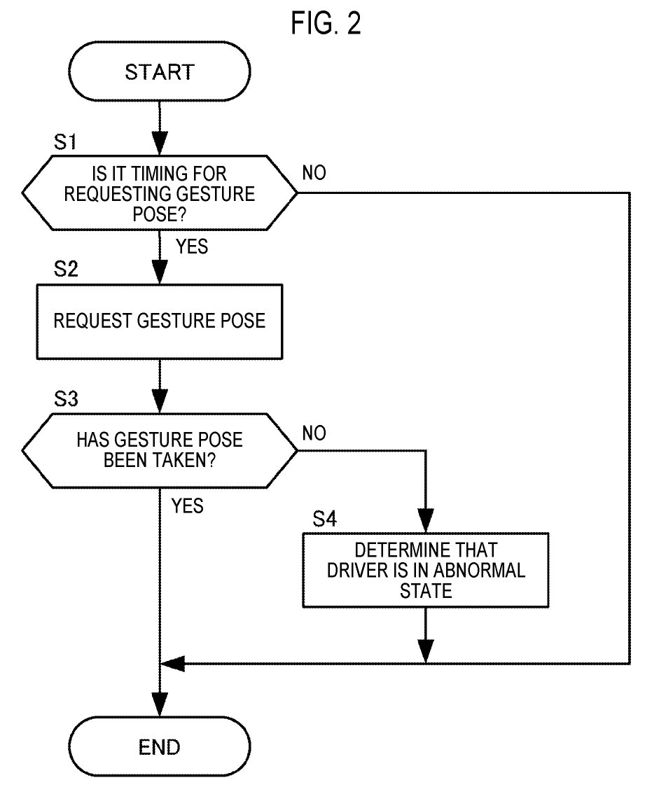

FIG. 2 is a flowchart illustrating details of a driver abnormal state determination process performed by the abnormal state determination unit 81 and, by extension, the control device 7.

In S1, the control device 7 determines whether it is a timing for requesting the gesture pose. When the request for the driver to take the gesture pose is issued periodically, the control device 7 determines that it is the timing for requesting the driver to take a gesture pose when a predetermined time has elapsed from the previous time. In addition, when the request for the driver to take a gesture pose is issued while the driver has fallen into an estimated abnormal state, the control device 7 determines that it is the timing for requesting the driver to take the gesture pose when the driver has fallen into the estimated abnormal state. When it is the timing for requesting the driver to take the gesture pose, the control device 7 proceeds to the process of S2. On the other hand, when it is not the timing for requesting the driver to take the gesture pose, the control device 7 ends the current process.

In S2, the control device 7 requests the driver to take the gesture pose via the output device 41.

In S3, the control device 7 determines whether the driver has taken the gesture pose. When it is possible to confirm that the driver has taken the gesture pose within a predetermined time after the request for the gesture pose, the control device 7 can determine that the driver is in the normal state, and thus ends the current process. On the other hand, when it is not possible to confirm that the driver has taken the gesture pose, the control device 7 proceeds to the process of S4.

As described above, whether the driver has taken the gesture pose can be confirmed from the appearance image of the driver. In addition, whether the driver has taken the gesture pose can be confirmed by issuing, to the wearable device worn by the driver, a transmission request for the result information of confirmation indicating whether the driver has taken the predetermined gesture pose, and by confirming based on the result information of confirmation received from the wearable device in response to the transmission request. In addition, whether the driver has taken the gesture pose can be confirmed by issuing, to the wearable device worn by the driver, a transmission request for the detection data from the wearable device for a certain period after requesting the driver to take the gesture pose, and by confirming based on the detection data received from the wearable device in response to the transmission request.

In S4, the control device 7 determines that the driver is in the abnormal state.

The control device 7 (driving assistance control device) of the vehicle 100 according to the present embodiment is configured to perform, in response to a determination that the driver of the vehicle 100 is in the abnormal state in which the driver has difficulty in continuing to drive the vehicle 100, driver-abnormal-state response driving assistance in order to respond to the abnormal state of the driver, and determine, when a predetermined gesture pose is requested of the driver and the driver does not take the predetermined gesture pose, that the driver is in the abnormal state.

As described above, according to the present embodiment, since it is possible to request the driver to take the predetermined gesture pose, confirm the response of the driver to the request, and determine whether the driver is in the abnormal state, it is possible to accurately determine whether the driver is in the abnormal state by a simple method.

The control device 7 can be configured to issue, to the wearable device worn by the driver, a transmission request for the detection data from the wearable device for a certain period after requesting the driver to take the predetermined gesture pose, and to confirm whether the driver has taken the predetermined gesture pose based on the detection data received from the wearable device in response to the transmission request.

As a result, for example, even in a scene in which the appearance image of the driver is likely to be unclear, such as at night, it is possible to accurately determine whether the driver is in the abnormal state.

In addition, the control device 7 can also be configured to issue, to the wearable device, a transmission request for the result information of a confirmation indicating whether the driver has taken the predetermined gesture pose, the confirmation being performed by the wearable device based on the detection data, and to confirm whether the driver has taken the predetermined gesture pose based on the result information received from the wearable device in response to the transmission request.

As a result, since a part of the process for confirming whether the driver has taken the predetermined gesture pose can be performed by the wearable device, the operation load of the control device 7 can be suppressed.

### Second Embodiment

Next, a second embodiment of the disclosure will be described. The present embodiment is different from the first embodiment in that the gesture pose of the driver can be registered. The difference will be mainly described below.

The gesture pose, for example, a thumbs-up "good" pose, may have a different shape for each driver. Therefore, in the present embodiment, the driver is requested to take the gesture pose, and the gesture pose is registered as a predetermined gesture pose to be compared with the gesture pose actually taken by the driver in a case of determining the abnormal state of the driver. As a result, since it is possible to confirm whether the driver has taken the gesture pose by comparing with the registered gesture, the recognition accuracy of the gesture pose can be improved. As a result, it is possible to more accurately determine whether the driver is in the abnormal state.

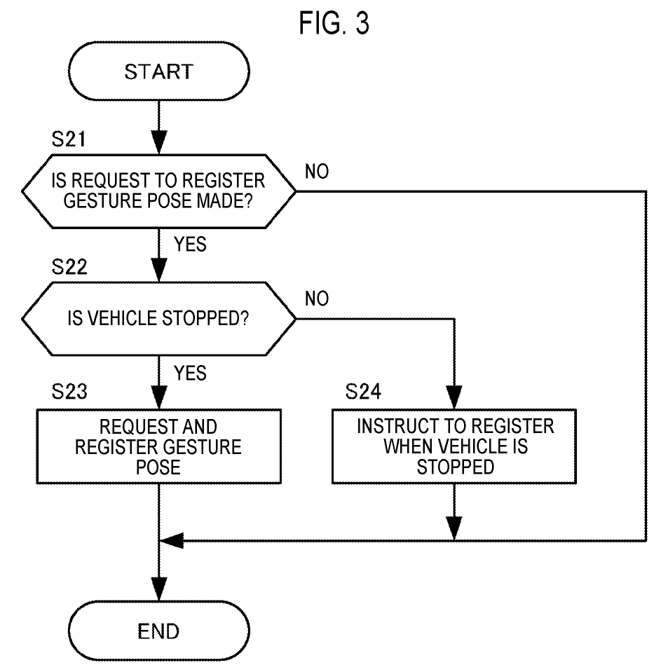

FIG. 3 is a flowchart illustrating details of a gesture registration process according to the present embodiment, the registration process of the gesture pose being performed by the driving assistance unit 83 and, by extension, the control device 7.

In S21, the control device 7 determines whether a request to register the gesture pose is made from the driver via the input device 42. When a request to register the gesture pose is made from the driver, the control device 7 proceeds to the process of S22. On the other hand, when there is no request to register the gesture pose from the driver, the control device 7 ends the current process.

In S22, the control device 7 determines whether the vehicle is stopped. When the vehicle is stopped, the control device 7 proceeds to the process of S23. On the other hand, when the vehicle is not stopped, the control device 7 proceeds to the process of S24.

In S23, the control device 7 instructs the driver to take the predetermined gesture pose a plurality of times via the input device 42, and each time, captures an image of the gesture pose taken by the driver via the driver monitoring camera 31, and extracts the gesture pose from the appearance image of the driver. The control device 7 stores the extracted gesture pose as a predetermined gesture pose to be compared with the gesture pose actually taken by the driver in a case of determining the abnormal state of the driver in the storage unit 72.

In S24, the control device 7 instructs the driver to request the registration of the gesture pose via the input device 42 when the vehicle is stopped.

The control device 7 according to the present embodiment is configured to request the driver to take the predetermined gesture pose when a request to register the gesture pose is made, and to register the gesture pose taken by the driver as the predetermined gesture.

As a result, since the recognition accuracy of the gesture pose can be improved, it is possible to more accurately determine whether the driver is in the abnormal state.

Although the embodiments of the disclosure have been described above, the above embodiments merely show a part of application examples of the disclosure, and are not intended to limit the technical scope of the disclosure to the specific configurations of the embodiments.

For example, in the second embodiment, the predetermined gesture pose is requested to be taken in a case of registering the gesture pose, but there may be a driver who has difficulty in taking the predetermined gesture pose for some reason or there may be a gesture pose that is easier to take than the predetermined gesture. Therefore, in the second embodiment, any gesture according to the driver's preference may be registered instead of the predetermined gesture pose.

In addition, for example, in the above-described embodiments, the computer program executed by the control device 7 may be provided in a form of being recorded on a computer-readable portable recording medium such as a semiconductor memory, a magnetic recording medium, or an optical recording medium, or may be provided as a computer program product.

What is claimed is:

1. A driving assistance control device for a vehicle, the driving assistance control device being configured to:
perform, in response to determination that a driver of the vehicle is in an abnormal state in which the driver has difficulty in continuing to drive the vehicle, driving assistance to respond to the abnormal state of the driver; and
determine, when a predetermined gesture pose is requested of the driver and the driver does not take the predetermined gesture pose, that the driver is in the abnormal state.

2. The driving assistance control device according to claim 1, wherein the driving assistance control device is configured to:
issue, to a wearable device worn by the driver, a transmission request for detection data from the wearable device for a certain period after requesting the driver to take the predetermined gesture pose, and confirm whether the driver has taken the predetermined gesture pose based on the detection data received from the wearable device in response to the transmission request; or
issue, to the wearable device, a transmission request for result information of a confirmation indicating whether the driver has taken the predetermined gesture pose, the confirmation being performed by the wearable device based on the detection data, and confirm whether the driver has taken the predetermined gesture pose based on the result information received from the wearable device in response to the transmission request.

3. The driving assistance control device according to claim 1, wherein the driving assistance control device is configured to request, when a request to register the predetermined gesture pose is made, the driver to take a gesture pose determined in advance or an arbitrary gesture pose, and register a gesture pose taken by the driver as the predetermined gesture pose, the gesture pose being selected from the gesture pose determined in advance and the arbitrary gesture pose.

4. A driving assistance method for a vehicle, the driving assistance method comprising:
performing, in response to determination that a driver of the vehicle is in an abnormal state in which the driver has difficulty in continuing to drive the vehicle, driving assistance to respond to the abnormal state of the driver; and
determining, when a predetermined gesture pose is requested of the driver and the driver does not take the predetermined gesture pose, that the driver is in the abnormal state.

5. A non-transitory storage medium storing a computer program causing a computer to execute:
performing, in response to determination that a driver of a vehicle is in an abnormal state in which the driver has difficulty in continuing to drive the vehicle, driving assistance to respond to the abnormal state of the driver; and
determining, when a predetermined gesture pose is requested of the driver and the driver does not take the predetermined gesture pose, that the driver is in the abnormal state.
